(19) United States
(12) Patent Application Publication
(10) Pub. No.: US 2017/0295049 A1
(43) Pub. Date: Oct. 12, 2017

(54) DUAL CARRIER MODULATION THAT MITIGATES PAPR

(71) Applicant: Marvell World Trade Ltd., St. Michael (BB)

(72) Inventors: Yakun SUN, San Jose, CA (US); Hongyuan ZHANG, Fremont, CA (US); Yan ZHANG, Palo Alto, CA (US)

(21) Appl. No.: 15/486,196

(22) Filed: Apr. 12, 2017

Related U.S. Application Data
(60) Provisional application No. 62/321,715, filed on Apr. 12, 2016.

(51) Int. Cl. H04L 27/26; H04L 1/00; H04L 27/18

(52) U.S. Cl. CPC H04L 27/2621; H04L 27/183; H04L 1/0042; H04W 84/12

(57) ABSTRACT

A communication device maps a plurality of bits to a first set of transmission symbols corresponding to a first set of subcarriers within a component communication channel. Transmission symbols among the first set of transmission symbols correspond to respective subsets of one or more bits, and transmission symbols among the first set of transmission symbols are single carrier transmission symbols. The communication device maps the plurality of bits to a second set of transmission symbols corresponding to a second set of subcarriers within the component communication channel. At least a subset of multiple transmission symbols in the second set of transmission symbols correspond to phase adjusted versions of transmission symbols in a corresponding at least a subset of multiple transmission symbols in the first set of transmission symbols. The communication device generates a transmission signal using the first set of transmission symbols and the second set of transmission symbols.

### CROSS REFERENCES TO RELATED APPLICATIONS

This application claims the benefit of U.S. Provisional Patent App. No. 62/321,715, entitled “BPSK Mapping for DCM Transmission,” filed on Apr. 12, 2016, the disclosure of which is hereby expressly incorporated herein by reference in its entirety.

### FIELD OF TECHNOLOGY

The present disclosure relates generally to wireless communication systems and, more particularly, to modulation techniques to improve range and/or robustness in the presence of narrow band interference.

### BACKGROUND

Wireless local area networks (WLANs) have evolved rapidly over the past decade, and development of WLAN standards such as the Institute for Electrical and Electronics Engineers (IEEE) 802.11 Standard family has improved single-user peak data throughput. For example, the IEEE 802.11b Standard specifies a single-user peak throughput of 11 megabits per second (Mbps), the IEEE 802.11a and 802.11g Standards specify a single-user peak throughput of 54 Mbps, the IEEE 802.11n Standard specifies a single-user peak throughput of 600 Mbps, and the IEEE 802.11ac Standard specifies a single-user peak throughput in the gigabits per second (Gbps) range. Future standards promise to provide even greater throughputs, such as throughputs in the tens of Gbps range.

### SUMMARY

In an embodiment, a method includes mapping, at a communication device, a plurality of bits to a first set of transmission symbols corresponding to a first set of subcarriers within a component communication channel. Transmission symbols among the first set of transmission symbols correspond to respective subsets of one or more bits, and transmission symbols among the first set of transmission symbols are single carrier transmission symbols. The method also includes mapping, at the communication device, the plurality of bits to a second set of transmission symbols corresponding to a second set of subcarriers within the component communication channel. At least a subset of multiple transmission symbols in the second set of transmission symbols correspond to phase adjusted versions of transmission symbols in a corresponding at least a subset of multiple transmission symbols in the first set of transmission symbols. The method further includes generating, at the communication device, a transmission signal for transmission in a communication network using the first set of transmission symbols and the second set of transmission symbols.

In another embodiment, an apparatus comprises a network interface device associated with a communication device. The network interface device is implemented using one or more integrated circuits (ICs), and the network interface device includes: a physical layer (PHY) processor implemented using the one or more ICs. The PHY processor includes a dual carrier modulator (DCM) configured to: map a plurality of bits to a first set of transmission symbols corresponding to a first set of subcarriers within a component communication channel, wherein transmission symbols among the first set of transmission symbols corresponds to respective subsets of one or more bits, and transmission symbols among the first set of transmission symbols are single carrier transmission symbols, and map the plurality of bits to a second set of transmission symbols corresponding to a second set of subcarriers within the component communication channel, wherein at least a subset of multiple transmission symbols in the second set of transmission symbols corresponds to phase adjusted versions of transmission symbols in a corresponding at least a subset of multiple transmission symbols in the first set of transmission symbols. The PHY processor is configured to generate a transmission signal for transmission in a communication network using the first set of transmission symbols and the second set of transmission symbols.

### BRIEF DESCRIPTION OF THE DRAWINGS

FIG. 1 is a block diagram of an example wireless local area network (WEAN) that utilizes dual carrier modulation (DCM), according to an embodiment.

FIG. 2A is a diagram of a physical layer (PHY) data unit in which payload data is modulated using DCM, according to an embodiment.

FIG. 2B is a diagram of another PRY data unit in which payload data is modulated using DCM, according to another embodiment.

FIG. 3 is a diagram of an example multi-user PHY data unit in which payload data is modulated using DCM, according to an embodiment.

FIG. 4 is a diagram of an example PRY processing unit for generating PHY data units in which payload data is modulated using DCM, according to an embodiment.

FIG. 5 is a diagram of a DCM technique, according to an embodiment.

FIG. 6 is a diagram of another DCM technique, according to another embodiment.

FIG. 7 is a diagram of yet another DCM technique, according to another embodiment.

FIG. 8 is a diagram of still another DCM technique, according to another embodiment.

FIG. 9 is a flow diagram of a method of generating a transmission signal, where the method employs DCM, according to an embodiment.

### DETAILED DESCRIPTION

In embodiments described below, dual carrier modulation (DCM) is utilized in a communication network to extend range and/or to increase robustness in the presence of narrowband interference. DCM is a modulation technique in which multiple instances of a transmission symbol are transmitted in different frequency portions of a communication channel. In some embodiments, to mitigate increased peak-to-average power (PAPR) caused by DCM, at least some repeated transmission symbols are phase adjusted.

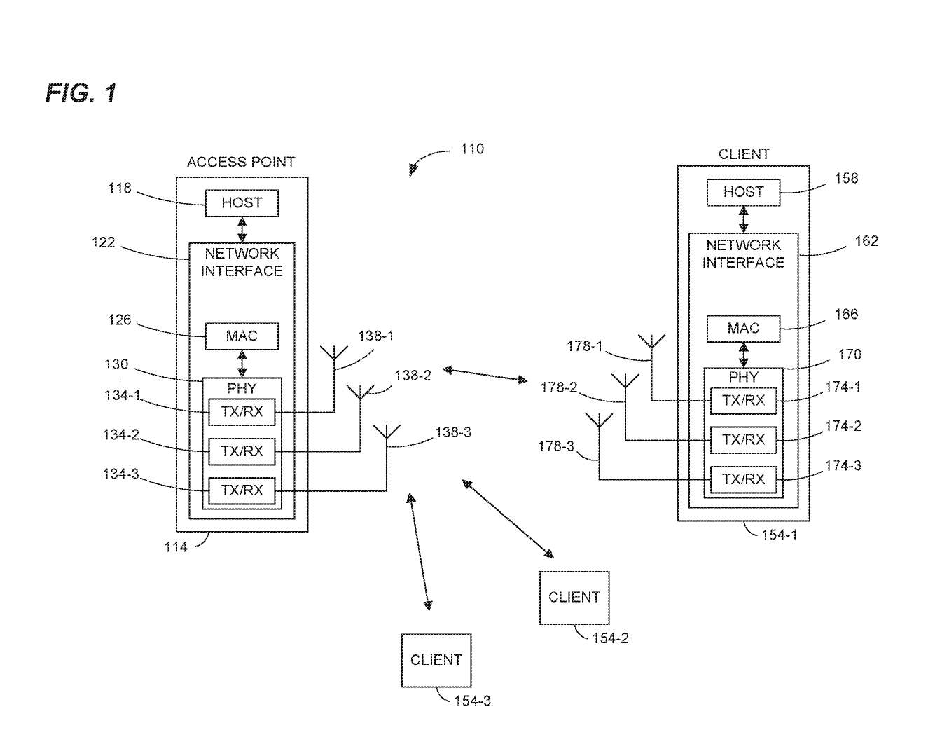

FIG. 1 is a block diagram of an example WLAN 110, according to an embodiment. The VVLAN 110 supports downlink (DL) and uplink (UL) single-user (SU) communication between an access point (AP) and each of a plurality of client stations. In an embodiment, the WLAN 110 also supports DL and/or UL multiuser (MU) orthogonal frequency division multiple access (OFDMA) communication between the AP and at least some of the client stations. In some embodiments, the WLAN 110 additionally or alternatively supports DL and/or UL MU multiple-input and multiple-output (MIMO) communication between the AP and at least some of the client stations.

The WLAN 110 includes an access point (AP) 114 that comprises a host processor 118 coupled to a network interface device 122. The network interface 122 includes a medium access control (MAC) processor 126 and a physical layer (PHY) processor 130. The PHY processor 130 includes a plurality of transceivers 134, and the transceivers 134 are coupled to a plurality of antennas 138. Although three transceivers 134 and three antennas 138 are illustrated in FIG. 1, the AP 114 includes other suitable numbers (e.g., 1, 2, 4, 5, etc.) of transceivers 134 and antennas 138 in other embodiments. In some embodiments, the AP 114 includes a higher number of antennas 138 than transceivers 134, and antenna switching techniques are utilized.

The network interface 122 is implemented using one or more integrate circuits (ICs) configured to operate as discussed below. For example, the MAC processor 126 may be implemented, at least partially, on a first IC, and the PHY processor 130 may be implemented, at least partially, on a second IC. As another example, at least a portion of the MAC processor 126 and at least a portion of the PHY processor 130 may be implemented on a single IC. For instance, the network interface 122 may be implemented using a system on a chip (SoC), where the SoC includes at least a portion of the MAC processor 126 and at least a portion of the PHY processor 130.

In various embodiments, the MAC processor 126 and/or the PHY processor 130 of the AP 114 are configured to generate data units, and process received data units, that conform to a WLAN communication protocol such as a communication protocol conforming to the IEEE 802.11 Standard (including future versions of the IEEE 802.11 Standard) or another suitable wireless communication protocol. For example, the MAC processor 126 may be configured to implement MAC layer functions, including MAC layer functions of the WLAN communication protocol, and the PHY processor 130 may be configured to implement PHY functions, including PHY functions of the WLAN communication protocol. For instance, the MAC processor 126 may be configured to generate MAC layer data units such as MAC service data units (MSDUs), MAC protocol data units (MPDUs), etc., and provide the MAC layer data units to the PITY processor 130. The PHY processor 130 may be configured to receive MAC layer data units from the MAC processor 126 and encapsulate the MAC layer data units to generate PHY data units such as PITY protocol data units (PPDUs) for transmission via the antennas 138. Similarly, the PHY processor 130 may be configured to receive PHY data units that were received via the antennas 138, and extract MAC layer data units encapsulated within the PITY data units. The PHY processor 130 may provide the extracted MAC layer data units to the MAC processor 126, which processes the MAC layer data units.

The WLAN 110 includes a plurality of client stations 154. Although three client stations 154 are illustrated in FIG. 1, the WLAN 110 includes other suitable numbers (e.g., 1, 2, 4, 5, 6, etc.) of client stations 154 in various embodiments. The client station 154-1 includes a host processor 158 coupled to a network interface device 162. The network interface 162 includes a MAC processor 166 and a PHY processor 170. The PHY processor 170 includes a plurality of transceivers 174, and the transceivers 174 are coupled to a plurality of antennas 178. Although three transceivers 174 and three antennas 178 are illustrated in FIG. 1, the client station 154-1 includes other suitable numbers (e.g., 1, 2, 4, 5, etc.) of transceivers 174 and antennas 178 in other embodiments. In some embodiments, the client station 154-1 includes a higher number of antennas 178 than transceivers 174, and antenna switching techniques are utilized.

The network interface 162 is implemented using one or more ICs configured to operate as discussed below. For example, the MAC processor 166 may be implemented on at least a first IC, and the PHY processor 170 may be implemented on at least a second IC. As another example, at least a portion of the MAC processor 166 and at least a portion of the PHY processor 170 may be implemented on a single IC. For instance, the network interface 162 may be implemented using an SoC, where the SoC includes at least a portion of the MAC processor 166 and at least a portion of the PHY processor 170.

In various embodiments, the MAC processor 166 and the PHY processor 170 of the client device 154-1 are configured to generate data units, and process received data units, that conform to the WLAN communication protocol or another suitable communication protocol. For example, the MAC processor 166 may be configured to implement MAC layer functions, including MAC layer functions of the WLAN communication protocol, and the PHY processor 170 may be configured to implement PHY functions, including PHY functions of the WLAN communication protocol. The MAC processor 166 may be configured to generate MAC layer data units such as MSDUs, MPDUs, etc., and provide the MAC layer data units to the PHY processor 170. The PHY processor 170 may be configured to receive MAC layer data units from the MAC processor 166 and encapsulate the MAC layer data units to generate PHY data units such as PPDUs for transmission via the antennas 178. Similarly, the PHY processor 170 may be configured to receive PHY data units that were received via the antennas 178, and extract MAC layer data units encapsulated within the PHY data units. The PHY processor 170 may provide the extracted MAC layer data units to the MAC processor 166, which processes the MAC layer data units.

In an embodiment, each of the client stations 154-2 and 154-3 has a structure that is the same as or similar to the client station 154-1. Each of the client stations 154-2 and 154-3 has the same or a different number of transceivers and antennas. For example, the client station 154-2 and/or the client station 154-3 each have only two transceivers and two antennas (not shown), according to an embodiment.

In various embodiments, the PHY processing unit 130 of the AP 114 is configured to generate PHY data units conforming to a WLAN communication protocol as per the techniques described hereinafter. The transceiver(s) 134 is/are configured to transmit the generated PHY data units via the antenna(s) 138. Similarly, the transceiver(s) 134 is/are configured to receive PHY data units via the antenna(s) 138.

In various embodiments, the PHY processing unit 170 of the client device 154-1 is configured to generate PHY data units conforming to a WLAN communication protocol as per the techniques described hereinafter. The transceiver(s) 174 is/are configured to transmit the generated PHY data units via the antenna(s) 178. Similarly, the transceiver(s) 174 is/are configured to receive PHY data units via the antenna(s) 178.

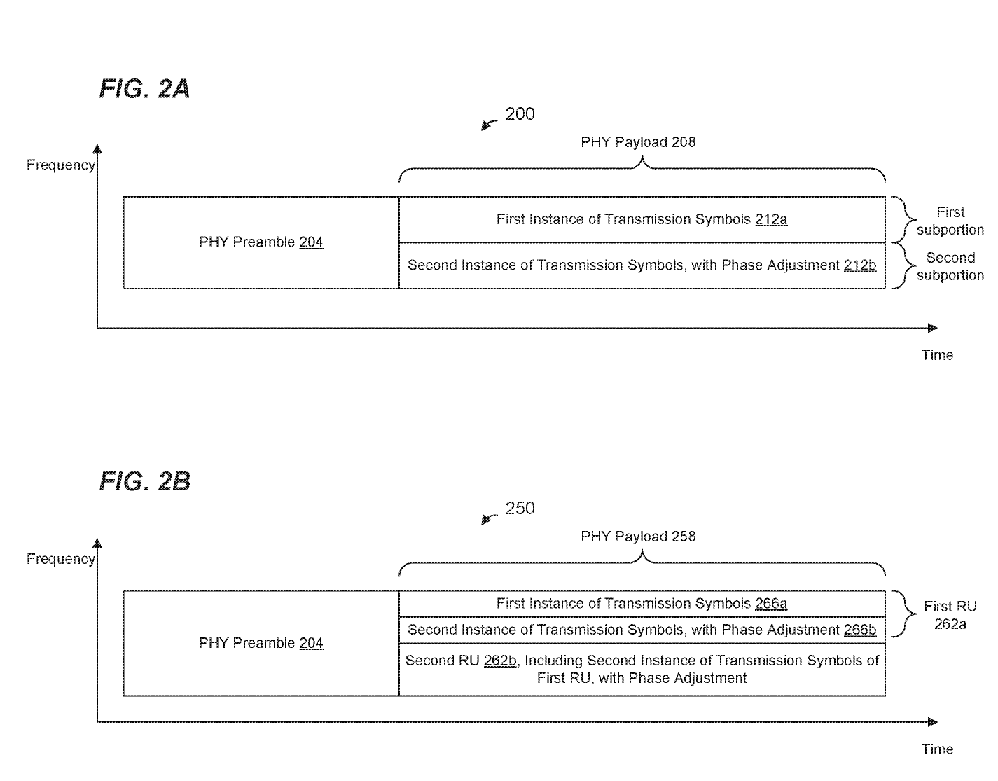

FIG. 2A is a diagram of a SU PHY data unit 200 that the network interface 122 (FIG. 1) is configured to generate and transmit to one client station 154 (e.g., the client station 154-1), according to an embodiment. The network interface 162 (FIG. 1) may also be configured to transmit data units the same as or similar to the data unit 200 to the AP 114. The data unit 200 may span a 20 MHz-wide communication channel or another suitable bandwidth such as 40 MHz, 80 MHz, 160 MHz, 320 MHz, 640 MHz, or other suitable bandwidths.

The PHY data unit 200 includes a PHY preamble 204 and a PHY payload portion 208. In an embodiment, the PHY preamble 204 includes one or more training fields for one or more of signal detection, synchronization, automatic gain control (AGC) adjustment, channel estimation, etc. In an embodiment, the PHY preamble 204 includes one or more PITY header fields that include PITY information regarding the payload 208, such as a modulation utilized for the payload 208, a length of the PHY data unit 200, etc.

The PHY payload 208 utilizes DCM, such that a first instance of transmission symbols 212a are correspond to a first frequency subportion of the channel, a second instance of transmission symbols 212b correspond to a second frequency subportion of the channel. As will be described in more detail below, the transmission symbols 212b include phase adjusted versions of transmission symbols from 212a.

At least some of the PHY preamble 204 does not utilize DCM. In an embodiment, no DCM is utilized in the PHY preamble 204. In another embodiment, one or more portions of the PHY preamble 204 do not utilize DCM, whereas one or more other portions of the PHY preamble 204 utilize DCM. In an embodiment, DCM utilized in the PHY preamble 204 applies a different phase adjustment scheme than used for the transmission symbols 212b in the PHY payload 208.

In an embodiment, allocation of OFDM subcarriers to one or more client stations 154 is performed using resource units (RUs). In an embodiment, an RU is a unit of frequency resources that can be allocated to one or more client stations for UL or DL transmissions. In an embodiment, available channel bandwidth (e.g., 20 MHz, 40 MHz, 80 MHz, 160 MHz, etc.) is divided into one or more RUs, each corresponding to a respective plurality of OFDM subcarriers. In an embodiment, a K-subcarrier RU corresponds to an RU with K OFDM subcarriers, wherein K is a suitable integer greater than zero. As just an illustrative example, in an embodiment, a 20 MHz bandwidth can be divided into nine 26-subcarrier RUs. In another embodiment, K is any suitable integer other than 26, and an RU therefore includes a suitable number of OFDM tones other than 26. For example, in various embodiments, K is 52, 106, 242, 484, 996 etc. As an illustrative example, a 20 MHz bandwidth can also be divided into four 52-subcarrier RUs and one 26-subcarrier RU. An RU allocated to a client station 154 (or allocated to a multi-user group of client stations 154, e.g., if MU-MIMO is being utilized) includes an integer number of basic K-subcarrier RUs. In some embodiments, a WLAN may utilize RUs with different sizes K in different situations. For example, in an embodiment, a WLAN may utilize RUs with different sizes K when utilizing communication channels of different bandwidths.

In an embodiment, the payload 208 corresponds to a single RU. In another embodiment, the first frequency subportion that includes transmission symbols 212a corresponds to a first RU, and the second frequency subportion that includes transmission symbols 212b corresponds to a second RU.

FIG. 2B is a diagram of another SU PHY data unit 250 that the network interface 122 (FIG. 1) is configured to generate and transmit to one client station 154 (e.g., the client station 154-1), according to an embodiment. The network interface 162 (FIG. 1) may also be configured to transmit data units the same as or similar to the data unit 250 to the AP 114. The data unit 250 may span a 20 MHz-wide communication channel or another suitable bandwidth such as 40 MHz, 80 MHz, 160 MHz, 320 MHz, 640 MHz, or other suitable bandwidths.

The PHY data unit 250 includes the PHY preamble 204 (discussed above with respect to FIG. 2A) and a PHY payload portion 258. The PHY payload 258 includes a first RU 262a and a second RU 262b. DCM is utilized in the first RU 262a such that a first instance of transmission symbols 266a correspond to a first frequency subportion of the first RU 262a, a second instance of transmission symbols 266b correspond to a second frequency subportion of the first RU 266a. As will be described in more detail below, the transmission symbols 266b include phase adjusted versions of transmissions symbols from 266a.

In an embodiment, DCM is utilized in with respect to the first RU 262a as a whole such that the first RU 262a includes a first instance of transmission symbols, and a second instance of the transmission symbols are correspond to the second RU 266b. As will be described in more detail below, the transmission symbols in 262b include phase adjusted versions of transmissions symbols from 262a.

As discussed above, at least some of the PHY preamble 204 does not utilize DCM. In an embodiment, no DCM is utilized in the PHY preamble 204. In another embodiment, one or more portions of the PHY preamble 204 do not utilize DCM, whereas one or more other portions of the PHY preamble 204 utilize DCM, but a different phase adjustment scheme is applied to transmission symbols within the PHY preamble 204 than used for the transmission symbols 266b or in the second RU 262b in the PHY payload 258.

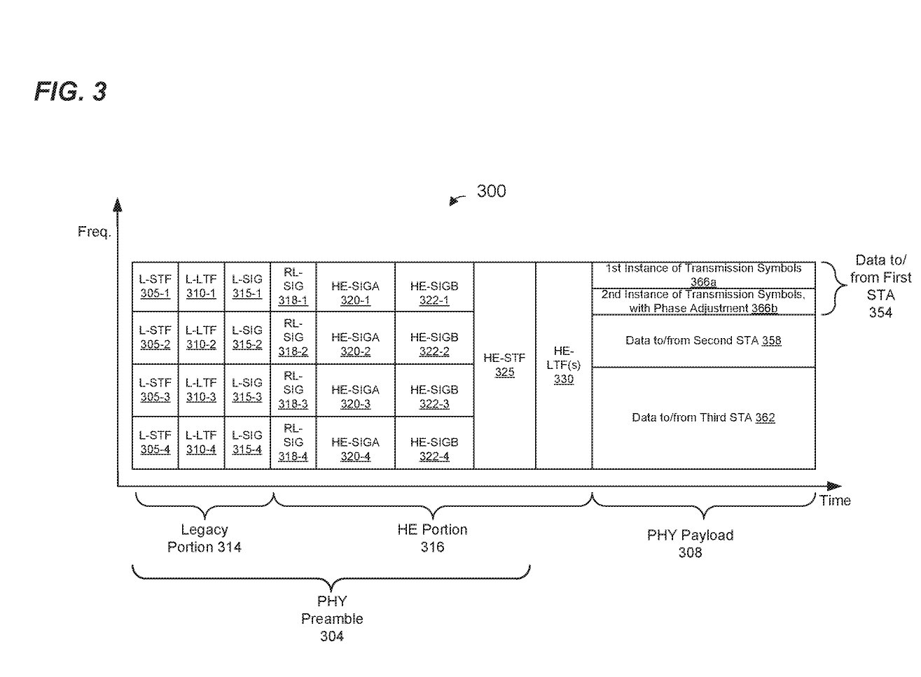

FIG. 3 is a diagram of a MU PHY data unit 300 that the network interface 122 (FIG. 1) is configured to transmit to multiple client stations 154, according to an embodiment. The network interface 162 (FIG. 1) may also be configured to generate and transmit data units the same as or similar to the data unit 300.

In an embodiment, the PHY data unit 300 is a DL OFDMA data unit in which independent data streams are transmitted to multiple client stations 154 using respective sets of OFDM subcarriers allocated to the client stations 154. In another embodiment, the PHY data unit 300 is an UL OFDMA data unit in which independent data streams are transmitted from multiple client stations 154 using respective sets of OFDM subcarriers allocated to the client stations 154. For example, in an embodiment, one or more RUs are allocated to respective one of the client stations 154 for transmission of data to, or by, the one or more of the client stations 154.

The PHY data unit 300 includes a PHY preamble 304 and a PHY data portion 308. The PHY preamble 304 includes a legacy portion 314 and a non-legacy portion 316 (sometimes referred to herein as a High Efficiency protocol portion or HE portion).

The legacy portion 314 includes a legacy short training field (L-STF) 305, a legacy long training field (L-LTF) 310, and a legacy signal field (L-SIG) 315. The HE portion 316 includes a repeated L-SIG (RL-SIG) 318, a high efficiency signal field A (HE-SIGA) 320, a high efficiency signal field B (HE-SIGH) 322, an HE short training field (HE-STF) 325, an HE long training field (HE-LTF) 330. Each of the L-STF 305, the L-LTF 310, and the L-SIG 315, the RL-SIG 318, HE-SIG-A 320, the HE-SIG-B 322, the IE-STF 325, and the HE-LTF 330 comprises one or more OFDM symbols.

In the embodiment of FIG. 3, the PHY data unit 300 includes one of each of the L-STF 305, the L-LTF 310, the L-SIG 315, RL-SIG 318 the HE-SIG-A 320, and HE-SIG-B 322 in each component channel. In an embodiment, each component channel spans a minimum channel bandwidth defined by a communication protocol. For example, each component channel may have a bandwidth of 20 MHz, which is a minimum channel bandwidth defined by a communication channel. In other embodiments, the minimum bandwidth defined by the communication channel is another suitable bandwidth (e.g., 1 MHz, 2 MHz, 5 MHz, 10 MHz, etc.), and each component channel spans the minimum bandwidth. In an embodiment, the PHY data unit 300 occupies a cumulative bandwidth of 80 MHz that spans multiple component channels. In other embodiments in which a data unit similar to the PHY data unit 300 occupies a another suitable cumulative bandwidth other than 80 MHz (e.g., 40 MHz, 160 MHz, 320 MHz, etc.), each of the L-STF 305, the L-LTF 310, the L-SIG 315, the RL-SIG 318, and HE-SIG-A 320 is repeated over a corresponding number of 20 MHz sub-bands of the whole bandwidth of the data unit, in an embodiment. In at least some embodiments, HE-SIG-B 322 carries different information over at least some of the 20 MHz sub-bands of the whole bandwidth of the data unit.

More specifically, in an embodiment, each HE-SIG-A 320 spans an individual component channel and is duplicated in other individual component channels. For example, in an embodiment, each HE-SIGA 320 spans an individual 20 MHz component channel and is duplicated in other individual 20 MHz component channels. In other embodiments, respective HE-SIGAs 320 in respective individual channels are not duplicates but rather may include different information. In an embodiment, respective HE-SIGBs 322 span respective individual component channels similar to the HE-SIGAs 220. In some embodiments, respective HE-SIGBs 322 in respective individual channels are not duplicates but rather may include different information.

In an embodiment, each of the HE-SIG-A 320 and the HE-SIG-B 322 generally carries information about the format of the PHY data unit 300, such as information needed to properly decode at least a portion of the PHY data unit 300, in an embodiment. In an embodiment in which the PITY data unit 300 is an MU data unit, HE-SIG-A 320 carries information commonly needed by multiple intended receivers of the PHY data unit 300. In some embodiments, HE-SIG-A 320 additionally includes information for client stations 154 that are not intended receivers of the PITY data unit 300, such as information needed for medium protection from the client stations 154 that are not receivers of the PHY data unit 300. On the other hand, HE-SIG-B 322 carries user-specific information individually needed by each client station 154 that is an intended recipient of the PHY data unit 300, in an embodiment. In an embodiment, HE-SIG-A 320 includes information needed to properly decode HE-SIG-B 322, and HE-SIG-B 322 includes information needed to properly decode data streams in the PHY data portion 308 of the PHY data unit 300. In some embodiments and/or scenarios, however, HE-SIG-A 320 includes at least some of the information needed to decode the data portion 308, and HE-SIG-B 322 is omitted from the PHY data unit 300 in at least some such embodiments.

Each of the HE-STF 325 and the HE-LTF 330 span the composite communication channel, in an embodiment.

In some embodiments and/or scenarios, the preamble 304 omits one or more of the fields 305-330. For example, the preamble 304 omits the HE-SIG-B 322, in an embodiment. In some embodiments, the preamble 304 includes additional fields not illustrated in FIG. 3.

The PITY payload 308 includes data 354 to/from a first client station, data 358 to/from a second client station, and data 362 to/from a third client station. The data 354 utilizes DCM, such that a first instance of transmission symbols 366a correspond to a first frequency subportion of a component channel corresponding to the data 354, and a second instance of transmission symbols 366b correspond to a second frequency subportion of the component channel. As will be described in more detail below, the transmission symbols 366b include phase adjusted versions of transmissions symbols from 366a.

At least some of the PHY preamble 304 does not utilize DCM. In an embodiment, no DCM is utilized in the PHY preamble 304. In another embodiment, one portion of the PHY preamble 304 (e.g., HE-STF 325, HE-LTF(s) 330) does not utilize DCM, whereas another portion of the PHY preamble 304 utilizes DCM. In an embodiment, DCM utilized in the PHY preamble 304 applies a different phase adjustment scheme than used for the transmission symbols 366b in the PITY payload 308.

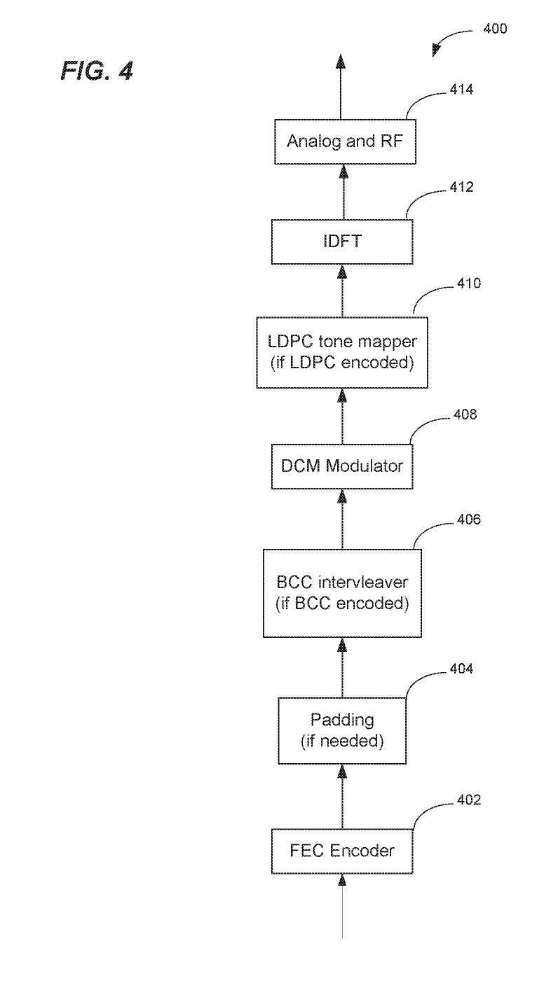

FIG. 4 is a block diagram a PHY processor 400 configured to generate PHY data units that utilize DCM, according to an embodiment. In various embodiments, the PHY processor 400 is included in the PHY processor 130 in the AP 114 and/or the PHY processor 170 in the client station 154-1.

A forward error correction (FEC) encoder 402 encodes incoming information bits according to an FEC schemed to generate encoded bits. In one embodiment, the FEC encoder 402 includes a binary convolutional code (BCC) encoder. In another embodiment, the FEC encoder 402 includes a low density parity check (LDPC) encoder. At block 404, padding bits are added to the encoded bits, if necessary. For instance, padding can be utilized so that the PHY data unit occupies an integer number of OFDM symbols. If BCC encoding is used, a BCC interleaver 406 receives the encoded bits and interleaves the bits (i.e., changes the order of the bits) to prevent long sequences of adjacent noisy bits from entering a decoder at the receiver. If LDPC encoding is used, the BCC interleaver 406 is omitted.

A DCM modulator 408 maps incoming encoded bits to transmission symbols and applies phase adjustments to some of the transmission symbols, as will be described in more detail below. In an embodiment, the DCM modulator 408 maps the encoded bits to transmission symbols corresponding to different subcarriers used for orthogonal frequency division multiplexing (OFDM) modulation.

In an embodiment, the DCM modulator 408 maps encoded bits to transmission symbols according to a modulation scheme in which a transmission symbol corresponding to a bit or set of bits can be generated with a single carrier (i.e., are single carrier transmission symbols, as opposed to multi-carrier transmission symbols generated according modulation schemes such as quadrature amplitude modulation (QAM)). In an embodiment, the transmission symbol can be generated with a single carrier no matter the value of the bit or set of bits. In embodiments utilizing OFDM, the DCM modulator 408, for each of at least some OFDM subcarriers, maps encoded bits to transmission symbols according to a modulation scheme in which a transmission symbol corresponding to a bit or set of bits can be generated with a single carrier. For example, the DCM modulator performs phase shift keying modulation such as binary phase shift keying (BPSK), quaternary BPSK (QBPSK), etc.

If LDPC encoding is used, an LDPC tone mapper 410 performs LDPC tone mapping by reordering, across OFDM subcarriers, the transmission symbols generated by the DCM modulator 408 according to a subcarrier (or tone) remapping function. If BCC encoding is used, the LDPC tone mapper 410 is omitted. The output of the LDPC tone mapper 410 (or DCM modulator 408, if BCC encoding is used) is operated on by an inverse discrete Fourier transform (IDFT) unit 412 that converts a block of transmission symbols corresponding to OFDM subcarriers to a time-domain signal sometimes referred to as an OFDM symbol. The analog and radio frequency (RF) unit 414 converts the time-domain signal to an analog signal and upconverts the analog signal to RF for transmission.

In various embodiments, the PHY processing unit 400 includes other processing blocks according to the communication protocol. For instance, in an embodiment, the output of the IDFT unit 412 is provided to a guard interval (GI) insertion and windowing unit that prepends, to each symbol of the time-domain signal, a circular extension of the symbol and smooths the edges of each symbol to increase spectral decay. The output of the GI insertion and windowing unit is provided to the analog and RF unit 414.

In an embodiment, the DCM modulator 408 generates two transmission symbols corresponding to two OFDM subcarriers for each encoded bit, which introduces redundancy to increase robustness. In an embodiment, wherein at least the portion of the PHY data unit is transmitted over N subcarriers within a component channel according to an OFDM scheme, the DCM modulator 408 maps a set of encoded bits to N OFDM subcarriers by flapping the encoded bits to a first half of the N subcarriers, and also mapping the encoded bits to a second half of the N subcarriers.

The PITY processor 400 is implemented using hardware circuitry alone, or both hardware circuitry and a processor executing machine readable instructions, according to various embodiments. For example, the DCM modulator 408 may be implemented using hardwired circuitry, or a processor executing machine readable instructions. As another example, the IDFT unit 412 may be implemented using any of various hardwired inverse fast Fourier transform (IFFT) circuits, or a processor executing machine readable instructions configured to implement any of various IFFT software programs. As yet another example, the analog and RE unit 414 may comprise a digital-to-analog converter (DAC), and an up-converter circuit that upconverts an analog baseband or intermediate frequency (IF) signal to and. RF signal for transmission in a communication network such as a WLAN.

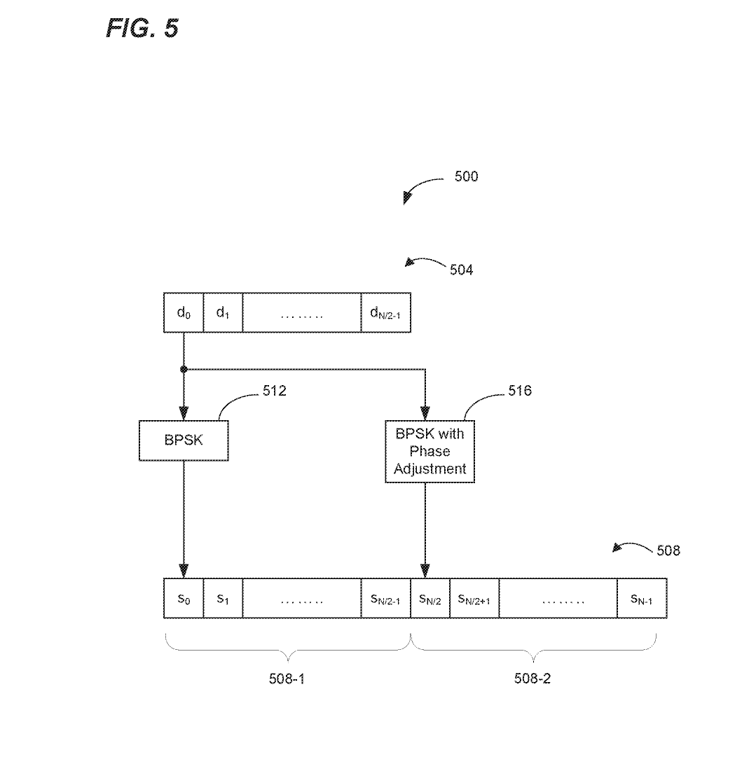

FIG. 5 is a block diagram of a DCM modulator 500 for use with OFDM, according to an embodiment. The DCM modulator 500 receives bits 504 and generates transmission symbols 508, where the transmission symbols 508 include a first set 508-1 that correspond to a first frequency subportion of a component channel, and a second set 508-2 that correspond to a second frequency subportion of the component channel. In an embodiment, the first set 508-1 corresponds to a first RU within a component channel, and the second set 508-2 corresponds to a second RU within the component channel.

In the illustrative example of FIG. 5, N OFDM subcarriers correspond to a first frequency subportion including subcarriers indexed from 0 to (N/2)−1, and a second frequency subportion including subcarriers indexed from N/2 to N−1. Transmission symbols corresponding to the first frequency subportion are represented as [s₀, . . . , s_{N/2-1}], and transmission symbols corresponding to the second frequency subportion are represented as [s_{N/2}, . . . , s_{N-1}].

The bits 504 are mapped to the transmission symbols 508-1 by a first BPSK mapper 512, and the bits 504 are mapped to the transmission symbols 508-2 by a second BPSK mapper 516. If the first BPSK mapper 512 and the second BPSK mapper 516 apply the exact same BPSK modulation, then the resulting transmission symbols could be represented as:

s_{n+N/2}=sₙ Equation 1

where

$$n = 0 , 1 , … , \frac{N}{2} - 1.$$

In an embodiment, the second BPSK mapper 516 applies a phase adjustment, as compared to the BPSK mapper 512, when generating at least some of the transmission symbols 508-2. In an embodiment, the phase adjustment applied by the second BPSK. mapper 516 can be represented as:

s_{n+N/2}=sₙ*e^{jθ(n)} Equation 2

where θ(n) represents an angle of rotation for a particular transmission symbol 508-2 indexed by n, as compared to the corresponding transmission symbol 508-1 indexed by n.

In some embodiments, a value of θ(n) is the same for

$$n = 0 , 1 , … , \frac{N}{2} - 1.$$

For example,

$$θ ( n ) = \frac{π}{2}$$

for n=

$$0 , 1 , … , \frac{N}{2} - 1.$$

As another example,

$$θ ( n ) = π for n = 0 , 1 , … , \frac{N}{2} - 1.$$

In other embodiments, θ(n) is another suitable value.

In some embodiments, a value of θ(n) is different for different values of n for

$$n = 0 , 1 , … , \frac{N}{2} - 1.$$

For example, θ(n)=0 for some values of n, whereas θ(n)=π for other values of n.

An angle of rotation of 0 radians corresponds to multiplication by +1, and an angle of rotation of π radians corresponds to a reversal in polarity, i.e., a multiplication by −1. Thus, according to some embodiments, Equation 2 can be rewritten as:

s_{n+N/2}=sₙ*p(n) Equation 3

where p(n)=+1 or −1, for different values of n. In an embodiment, multiplication by −1, as in Equation 3, corresponds to a phase adjustment of 180°. In one embodiment, p(n) is defined as:

$$\begin{matrix}p ( n ) = 1 for n = 0 … floor ( \frac{N}{4} ) ; \\ = - 1 , otherwise\end{matrix} \qquad Equation 4$$

In another embodiment, p(n) is defined as:

$$\begin{matrix}p ( n ) = - 1 for n = 0 … floor ( \frac{N}{4} ) ; \\ = 1 , otherwise\end{matrix} \qquad Equation 5$$

In other embodiments, the floor function in Equations 4 and 5 can be replaced by a ceiling function. For situations where N is a multiple of 4, Equation 4 results in constellation points corresponding to a fourth quarter of N subcarriers to be rotated in polarity. Similarly, where N is a multiple of 4, Equation 5 results in constellation points corresponding to a third quarter of N subcarriers to be rotated in polarity. When p(n) corresponds to Equations 4 or 5, a first contiguous set of transmission symbols 508-2 is the same as a corresponding first set of transmission symbols 508-1, and a second contiguous set of transmission symbols 508-2 corresponds to a second set of transmission symbols 508-1, but with opposite polarity.

In other embodiments, every alternate transmission symbol 508-2 are subject to a rotation in polarity with respect to transmission symbols 508-1. In such embodiments, p(n) can be defined as:

$$\begin{matrix}p ( n ) = - 1 for mod ( n , 2 ) = 0 ; \\ = 1 , otherwise\end{matrix} \qquad Equation 6$$

or as,

$$\begin{matrix}p ( n ) = 1 for mod ( n , 2 ) = 0 ; \\ = - 1 , otherwise\end{matrix} \qquad Equation 7$$

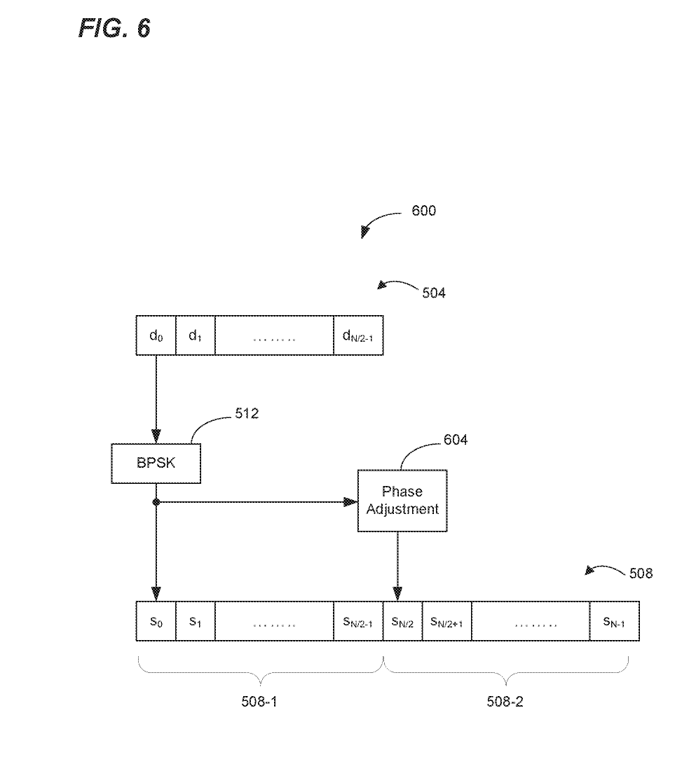

In the embodiment illustrated in FIG. 5, the DCM modulator 500 is illustrated as including two BPSK mappers 512, 516, each mapper mapping encoded bits to transmission symbols corresponding to respective frequency subportions 508. In some embodiments, the DCM modulator 500 includes one BPSK mapper that is utilized for multiple frequency subportions, where a phase adjustment function is applied for transmission symbols in one frequency subportions For example, FIG. 6 is a block diagram of a DCM modulator 600 for use with OFDM, according to another embodiment. The DCM modulator 600 is similar to the DCM modulator 500 of FIG. 5, and like-numbered elements are not described in detail for purposes of brevity.

The DCM modulator 600 includes a phase adjuster 604 that applies a phase adjustment to BPSK-modulated transmission symbols 508-2. When phase adjustment corresponds to multiplication by +1, the phase adjuster 604 is configured to act in a pass-through mode in which a transmission symbol generated by the BPSK mapper 512 is not operated upon by the phase adjuster 604, in an embodiment.

In FIGS. 5 and 6, the BPSK mapper 516 and the phase adjuster 604 are illustrated as generating all transmit symbols 508-2. In some embodiments, however, some of the transmit symbols 508-2 are generated by the BPSK mapper 512 without involvement of the BPSK mapper 516 or the phase adjuster 604. For example, for transmission symbols 508-2 that correspond to a phase adjustment of +1 can be generated by the BPSK mapper 512 without involvement of the BPSK mapper 516 or the phase adjuster 604, in some embodiments.

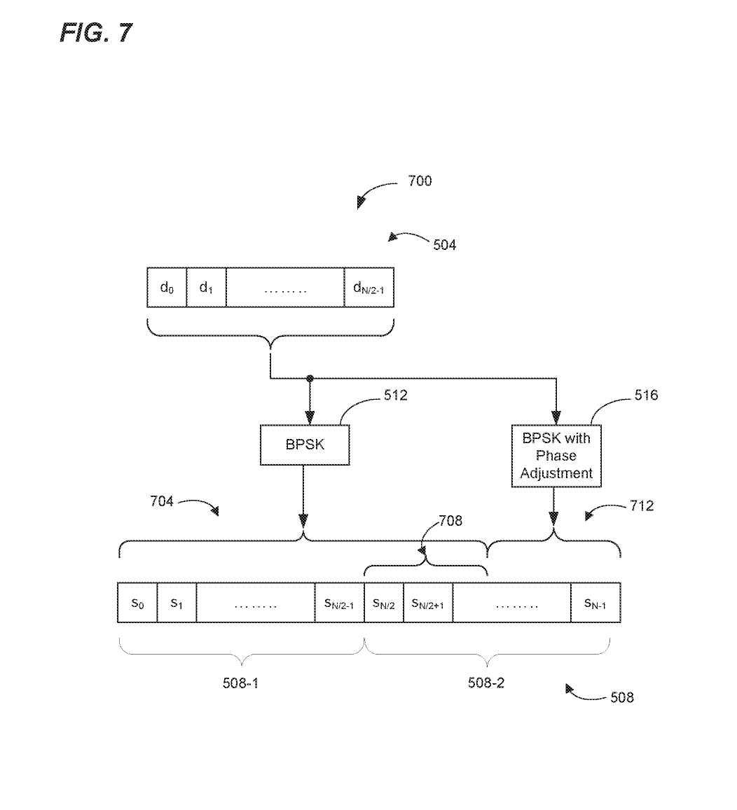

FIG. 7 is a block diagram of a DCM modulator 700 for use with OFDM, according to another embodiment. The DCM modulator 700 is similar to the DCM modulator 500 of FIG. 5, and like-numbered elements are not described in detail for purposes of brevity.

With the DCM modulator 700, the BPSK mapper 512 receives the bits 504 and generates a first set of transmission symbols 704, which includes all of the transmission symbols 508-1 and a first subset 708 of the transmission symbols 508-2. The BPSK mapper 516 receives at least some of the bits 504 and generates a second set of transmission symbols 712, which includes a second subset of the transmission symbols 508-2. In an embodiment, the BPSK mapper 516 receives only a subset of the bits 504 that correspond to the second subset 712 of the transmission symbols 508-2.

In an embodiment, the first subset 708 of transmission symbols 508-2 is a contiguous (with respect to the index n) set of transmission symbols, and the second subset 712 of transmission symbols 508-2 is also a contiguous (with respect to the index n) set of transmission symbols, such as when the DCM modulator 700 operates according to Equation 4 or Equation 5. In other embodiments, the first subset 708 of transmission symbols 508-2 is a non-contiguous (with respect to the index n) set of transmission symbols, and the second subset 712 of transmission symbols 508-2 is also a non-contiguous (with respect to the index n) set of transmission symbols. For example, the first subset 708 of transmission symbols and the second subset 712 of transmission symbols may be interleaved, with respect to the index n, such as when the DCM modulator 700 operates according to Equation 6 or Equation 7.

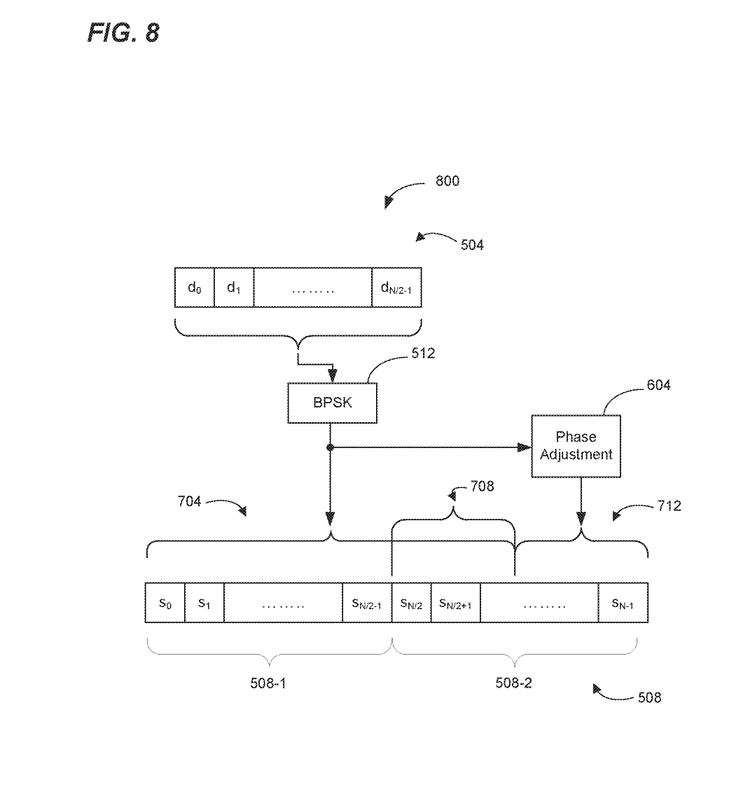

FIG. 8 is a block diagram of a DCM modulator 800 for use with OFDM, according to yet another embodiment. The DCM modulator 800 is similar to the DCM modulator 700 of FIG. 7, but utilizes the single mapper 512 and the phase adjuster 604 similar to the embodiment described with respect to FIG. 6.

Although FIGS. 5-8 were described in the context of BPSK mappers, other mappers for other types of modulation are utilized in other embodiments, where the mapper generates single carrier transmission symbols (i.e., as opposed to multi-carrier transmission symbols generated according modulation schemes such as QAM). For example, the mapper may correspond to QBPSK, amplitude shift keying (ASK) modulation, etc.

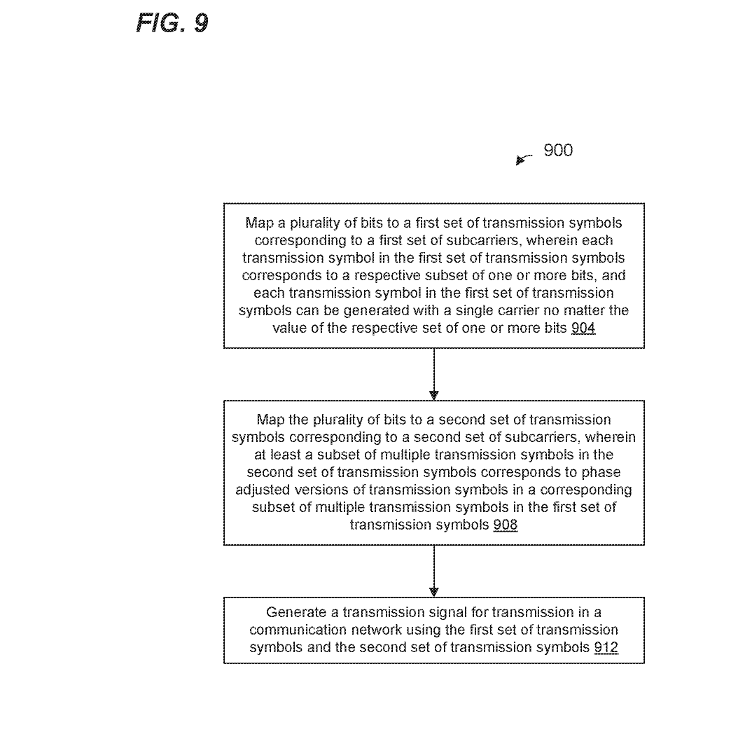

FIG. 9 is a flow diagram of an example method 900 for generating a transmission signal for transmission in a communication network, according to an embodiment. In various embodiments, the network interface device 122 (FIG. 1) and/or the network interface device 162 (Fig. Ii) are configured to implement the method 900. For example, the PHY processor 130 (FIG. 1) may be configured to implement the method 900, and/or the PHY processor 170 (FIG. 1) may be configured to implement the method 900.

In another embodiment, the PHY processor 400 (FIG. 4) is configured to implement the method 900. The method 900 is described in the context of the PHY processor 400 (FIG. 4) and the DCM mappers of FIGS. 5-8 merely for explanatory purposes and, in other embodiments, the method 900 is implemented by another suitable device.

At block 904, a plurality of bits are mapped to a first set of transmission symbols corresponding to a first set of subcarriers. Transmission symbols among the first set of transmission symbols correspond to a respective subsets of one or more bits. Additionally, transmission symbols among the first set of transmission symbols are single carrier transmission symbols (as opposed to multi-carrier transmission symbols generated according modulation schemes such as QAM), according to an embodiment. In an embodiment, block 904 is implemented by the DCM modulator 408 (FIG. 4). In an embodiment, the plurality of bits 504 (FIGS. 5-8) may be mapped to a first set of transmission symbols 508-1 (FIGS. 5-8) by the BPSK mapper 512.

The plurality of bits may be encoded bits that were encoded (e.g., by the FEC encoder 402 of FIG. 4) by a BCC encoder, an LDPC encoder, or another suitable error correction code encoder.

At block 908, the plurality of bits are mapped to a second set of transmission symbols corresponding to a second set of subcarriers. At least a subset of multiple transmission symbols in the second set of transmission symbols corresponds to phase adjusted versions of transmission symbols in a corresponding subset of multiple transmission symbols in the first set of transmission symbols. In an embodiment, block 908 is implemented by the DCM modulator 408 (FIG. 4). In various embodiments, the plurality of bits 504 (FIGS. 5-8) may be mapped to a second set of transmission symbols 508-2 by the BPSK mapper 516 (FIG. 5), the BPSK mapper 512 and the BPSK mapper 516 (FIG. 7), or the BPSK mapper 512 and the phase adjuster 604 (FIGS. 6 and 8).

At block 912, a transmission signal is generated using the transmission. symbols generated at blocks 904 and 908. In an embodiment, block 912 is implemented using the IDFT unit 412 of FIG. 4. In all embodiment, block 912 is also implemented using the analog and RF unit 414 of FIG. 4.

Phase adjustment techniques such as described above with reference to FIGS. 5-9 reduce PAPR caused by DCM. Thus, the DCM techniques described above with reference to FIGS. 4-9 provide increased range and/or robustness against narrow band interference, while reducing PAPR as compared to DCM alone.

In an embodiment, a method includes mapping, at a communication device, a plurality of bits to a first set of transmission symbols corresponding to a first set of subcarriers within a component communication channel. Transmission symbols among the first set of transmission symbols correspond to respective subsets of one or more bits, and transmission symbols among the first set of transmission symbols are single carrier transmission symbols. The method also includes mapping, at the communication device, the plurality of bits to a second set of transmission symbols corresponding to a second set of subcarriers within the component communication channel. At least a subset of multiple transmission symbols in the second set of transmission symbols correspond to phase adjusted versions of transmission symbols in a corresponding at least a subset of multiple transmission symbols in the first set of transmission symbols. The method further includes generating, at the communication device, a transmission signal for transmission in a communication network using the first set of transmission symbols and the second set of transmission symbols.

In other embodiments, the method further includes one of, or any suitable combination of two or more of, the following features,

Mapping the plurality of bits to the second set of transmission symbols comprises mapping the plurality of bits to the second set of transmission symbols such that all transmission symbols in the second set of transmission symbols correspond to phase adjusted versions of transmission symbols in the first set of transmission symbols.

All transmission symbols in the second set of transmission symbols are adjusted by a same phase as compared to transmission symbols in the first set of transmission symbols.

The same phase is π/2 radians.

Mapping the plurality of bits to the second set of transmission symbols comprises mapping the plurality of bits to the second set of transmission symbols such that the at least the subset of multiple transmission symbols in the second set of transmission symbols corresponds to versions, that are phase shifted by 180°, of transmission symbols in the corresponding at least the subset of multiple transmission symbols in the first set of transmission symbols.

Mapping the plurality of bits to the second set of transmission symbols comprises mapping the plurality of bits to the second set of transmission symbols such that: i) a first subset of multiple transmission symbols in the second set of transmission symbols are the same as a first subset of multiple transmission symbols in the first set of transmission symbols, and ii) a second subset of multiple transmission symbols in the second set of transmission symbols corresponds to versions of transmission symbols in a second subset of multiple transmission symbols in the first set of transmission symbols that are phase shifted by 180°.

The first subset of multiple transmission symbols in the second set of transmission symbols are contiguous with respect to a subcarrier index; and the second subset of multiple transmission symbols in the second set of transmission symbols are contiguous with respect to the subcarrier index.

Transmission symbols in the first subset of multiple transmission symbols in the second set of transmission symbols alternate, with respect to a subcarrier index, with symbols in the second subset of multiple transmission symbols in the second set of transmission symbols.

Mapping the plurality of bits to the first set of transmission symbols comprises mapping the plurality of bits to a first set of binary phase shift keying (BPSK) transmission symbols; and mapping the plurality of bits to the second set of transmission symbols comprises mapping the plurality of bits to a second set of BPSK transmission symbols.

The method further comprises at least one of: i) encoding, at the communication device, the plurality of bits using a forward error correction encoder prior to a) mapping the plurality of bits to the first set of transmission symbols and b) mapping the plurality of bits to the second set of transmission symbols; and ii) reordering, at the communication device, the first set of transmission symbols and the second set of transmission symbols with respect to a subcarrier index.

The component communication channel has a bandwidth equal to 20 MHz.

The transmission signal corresponds to a physical layer (PHY) data unit; the first set of transmission symbols and the second set of transmission symbols correspond to a PHY payload of the PITY data unit; and dual carrier modulation (DCM) is not utilized for any transmission symbols, on subcarriers within the component channel, corresponding to a PHY preamble of the PHY data unit.

In another embodiment, an apparatus comprises a network interface device associated with a communication device. The network interface device is implemented using one or more integrated circuits (ICs), and the network interface device includes: a physical layer (PHY) processor implemented using the one or more ICs. The PHY processor includes a dual carrier modulator (DCM) configured to: map a plurality of bits to a first set of transmission symbols corresponding to a first set of subcarriers within a component communication channel, wherein transmission symbols among the first set of transmission symbols corresponds to respective subsets of one or more bits, and transmission symbols among the first set of transmission symbols are single carrier transmission symbols, and map the plurality of bits to a second set of transmission symbols corresponding to a second set of subcarriers within the component communication channel, wherein at least a subset of multiple transmission symbols in the second set of transmission symbols corresponds to phase adjusted versions of transmission symbols in a corresponding at least a subset of multiple transmission symbols in the first set of transmission symbols. The PHY processor is configured to generate a transmission signal for transmission in a communication network using the first set of transmission symbols and the second set of transmission symbols.

In other embodiments, the apparatus further includes one of, or any suitable combination of two or more of, the following features.

The DCM is configured to map the plurality of bits to the second set of transmission symbols such that all transmission symbols in the second set of transmission symbols correspond to phase adjusted versions of transmission symbols in the first set of transmission symbols.

The DCM is configured to adjust all transmission symbols in the second set of transmission symbols by a same phase as compared to transmission symbols in the first set of transmission symbols.

The same phase is π/2 radians.

The DCM is configured to map the plurality of bits to the second set of transmission symbols such that the at least the subset of multiple transmission symbols in the second set of transmission symbols corresponds to versions, that are phase shifted by 180°, of transmission symbols in the corresponding at least the subset of multiple transmission symbols in the first set of transmission symbols.

The DCM is configured to map the plurality of bits to the second set of transmission symbols such that: a first subset of multiple transmission symbols in the second set of transmission symbols are the same as a first subset of multiple transmission symbols in the first set of transmission symbols, and a second subset of multiple transmission symbols in the second set of transmission symbols corresponds to versions of transmission symbols in a second subset of multiple transmission symbols in the first set of transmission symbols that are phase shifted by 180°.

The DCM is configured to map the plurality of bits to the second set of transmission symbols such that: the first subset of multiple transmission symbols in the second set of transmission symbols are contiguous with respect to a subcarrier index; and the second subset of multiple transmission symbols in the second set of transmission symbols are contiguous with respect to the subcarrier index.

The DCM is configured to map the plurality of bits to the second set of transmission symbols such that transmission symbols in the first subset of multiple transmission symbols in the second set of transmission symbols alternate, with respect to a subcarrier index, with symbols in the second subset of multiple transmission symbols in the second set of transmission symbols.

The transmission signal corresponds to a PHY data unit; the first set of transmission symbols and the second set of transmission symbols correspond to a PHY payload of the PHY data unit; and the PHY processor does not utilize dual carrier modulation for any transmission symbols, on subcarriers within the component channel, corresponding to a PHY preamble of the PHY data unit.

The network interface device further comprises: a media access control layer (MAC) processor implemented using the one or more ICs, the MAC processor coupled to the PHY processor.

The apparatus further comprises one or more antennas coupled to the network interface device.

At least some of the various blocks, operations, and techniques described above may be implemented utilizing hardware, a processor executing firmware instructions, a processor executing software instructions, or any combination thereof. When implemented utilizing a processor executing software or firmware instructions, the software or firmware instructions may be stored in any computer readable memory such as on a magnetic disk, an optical disk, or other storage medium, in a RAM or ROM or flash memory, processor, hard disk drive, optical disk drive, tape drive, etc. The software or firmware instructions may include machine readable instructions that, when executed by one or more processors, cause the one or more processors to perform various acts.

When implemented in hardware, the hardware may comprise one or more of discrete components, an integrated circuit, an application-specific integrated circuit (ASIC), a programmable logic device (PLD), etc.

While the present invention has been described with reference to specific examples, which are intended to be illustrative only and not to be limiting of the invention, changes, additions and/or deletions may be made to the disclosed embodiments without departing from the scope of the invention.

What is claimed is:

1. A method, comprising:
mapping, at a communication device, a plurality of bits to a first set of transmission symbols corresponding to a first set of subcarriers within a component communication channel, wherein transmission symbols among the first set of transmission symbols correspond to respective subsets of one or more bits, and transmission symbols among the first set of transmission symbols are single carrier transmission symbols;
mapping, at the communication device, the plurality of bits to a second set of transmission symbols corresponding to a second set of subcarriers within the component communication channel, wherein at least a subset of multiple transmission symbols in the second set of transmission symbols corresponds to phase adjusted versions of transmission symbols in a corresponding at least a subset of multiple transmission symbols in the first set of transmission symbols; and
generating, at the communication device, a transmission signal for transmission in a communication network using the first set of transmission symbols and the second set of transmission symbols.

2. The method of claim 1, wherein mapping the plurality of bits to the second set of transmission symbols comprises:
mapping the plurality of bits to the second set of transmission symbols such that all transmission symbols in the second set of transmission symbols correspond to phase adjusted versions of transmission symbols in the first set of transmission symbols.

3. The method of claim 2, wherein all transmission symbols in the second set of transmission symbols are adjusted by a same phase as compared to transmission symbols in the first set of transmission symbols.

4. The method of claim 3, wherein the same phase is π/2 radians.

5. The method of claim 1, wherein mapping the plurality of bits to the second set of transmission symbols comprises:
mapping the plurality of bits to the second set of transmission symbols such that the at least the subset of multiple transmission symbols in the second set of transmission symbols corresponds to versions, that are phase shifted by 180°, of transmission symbols in the corresponding at least the subset of multiple transmission symbols in the first set of transmission symbols.

6. The method of claim 5, wherein mapping the plurality of bits to the second set of transmission symbols comprises:
mapping the plurality of bits to the second set of transmission symbols such that:
a first subset of multiple transmission symbols in the second set of transmission symbols are the same as a first subset of multiple transmission symbols in the first set of transmission symbols, and
a second subset of multiple transmission symbols in the second set of transmission symbols corresponds to versions of transmission symbols in a second subset of multiple transmission symbols in the first set of transmission symbols that are phase shifted by 180°.

7. The method of claim 6, wherein:
the first subset of multiple transmission symbols in the second set of transmission symbols are contiguous with respect to a subcarrier index; and
the second subset of multiple transmission symbols in the second set of transmission symbols are contiguous with respect to the subcarrier index.

8. The method of claim 6, wherein:
transmission symbols in the first subset of multiple transmission symbols in the second set of transmission symbols alternate, with respect to a subcarrier index, with symbols in the second subset of multiple transmission symbols in the second set of transmission symbols.

9. The method of claim 1, wherein:
mapping the plurality of bits to the first set of transmission symbols comprises mapping the plurality of bits to a first set of binary phase shift keying (BPSK) transmission symbols; and
mapping the plurality of bits to the second set of transmission symbols comprises mapping the plurality of bits to a second set of BPSK transmission symbols.

10. The method of claim 1, further comprising at least one of:
i) encoding, at the communication device, the plurality of bits using a forward error correction encoder prior to a) mapping the plurality of bits to the first set of transmission symbols and b) mapping the plurality of bits to the second set of transmission symbols; and
ii) reordering, at the communication device, the first set of transmission symbols and the second set of transmission symbols with respect to a subcarrier index.

11. The method of claim 1, wherein:
the component communication channel has a bandwidth equal to 20 MHz.

12. The method of claim 1, wherein:
the transmission signal corresponds to a physical layer (PHY) data unit;
the first set of transmission symbols and the second set of transmission symbols correspond to a PHY payload of the PHY data unit; and
dual carrier modulation (DCM) is not utilized for any transmission symbols, on subcarriers within the component channel, corresponding to a PHY preamble of the PHY data unit.

13. An apparatus, comprising:
a network interface device associated with a communication device, wherein the network interface device is implemented using one or more integrated circuits (ICs), wherein the network interface device includes:
a physical layer (PHY) processor implemented using the one or more ICs, the PHY processor including a dual carrier modulator (DCM) configured to:
map a plurality of bits to a first set of transmission symbols corresponding to a first set of subcarriers within a component communication channel, wherein transmission symbols among the first set of transmission symbols corresponds to respective subsets of one or more bits, and transmission symbols among the first set of transmission symbols are single carrier transmission symbols, and
map the plurality of bits to a second set of transmission symbols corresponding to a second set of subcarriers within the component communication channel, wherein at least a subset of multiple transmission symbols in the second set of transmission symbols corresponds to phase adjusted versions of transmission symbols in a corresponding at least a subset of multiple transmission symbols in the first set of transmission symbols;
wherein the PHY processor is configured to generate a transmission signal for transmission in a communication network using the first set of transmission symbols and the second set of transmission symbols.

14. The apparatus of claim 13, wherein the DCM is configured to:
map the plurality of bits to the second set of transmission symbols such that all transmission symbols in the second set of transmission symbols correspond to phase adjusted versions of transmission symbols in the first set of transmission symbols.

15. The apparatus of claim 14, wherein the DCM is configured to:
adjust all transmission symbols in the second set of transmission symbols by a same phase as compared to transmission symbols in the first set of transmission symbols.

16. The apparatus of claim 15, wherein the same phase is π/2 radians.

17. The apparatus of claim 13, wherein the DCM is configured to:
map the plurality of bits to the second set of transmission symbols such that the at least the subset of multiple transmission symbols in the second set of transmission symbols corresponds to versions, that are phase shifted by 180°, of transmission symbols in the corresponding at least the subset of multiple transmission symbols in the first set of transmission symbols.

18. The apparatus of claim 17, wherein the DCM is configured to:
map the plurality of bits to the second set of transmission symbols such that:
a first subset of multiple transmission symbols in the second set of transmission symbols are the same as a first subset of multiple transmission symbols in the first set of transmission symbols, and
a second subset of multiple transmission symbols in the second set of transmission symbols corresponds to versions of transmission symbols in a second subset of multiple transmission symbols in the first set of transmission symbols that are phase shifted by 180°.

19. The apparatus of claim 18, wherein the DCM is configured to map the plurality of bits to the second set of transmission symbols such that:
the first subset of multiple transmission symbols in the second set of transmission symbols are contiguous with respect to a subcarrier index; and
the second subset of multiple transmission symbols in the second set of transmission symbols are contiguous with respect to the subcarrier index.

20. The apparatus of claim 18, wherein the DCM is configured to map the plurality of bits to the second set of transmission symbols such that:
transmission symbols in the first subset of multiple transmission symbols in the second set of transmission symbols alternate, with respect to a subcarrier index, with symbols in the second subset of multiple transmission symbols in the second set of transmission symbols.

21. The apparatus of claim 13, wherein:
the transmission signal corresponds to a PHY data unit;
the first set of transmission symbols and the second set of transmission symbols correspond to a PHY payload of the PHY data unit; and
the PHY processor does not utilize dual carrier modulation for any transmission symbols, on subcarriers within the component channel, corresponding to a PHY preamble of the PHY data unit.

22. The apparatus of claim 13, wherein the network interface device further comprises:
a media access control layer (MAC) processor implemented using the one or more ICs, the MAC processor coupled to the PHY processor.

23. The apparatus of claim 13, further comprising:
one or more antennas coupled to the network interface device.
